(19) United States
(12) Patent Application Publication
(10) Pub. No.: US 2025/0360442 A1
(43) Pub. Date: Nov. 27, 2025

(54) POST FILTER SET CONFIGURATION FOR A WATER TREATMENT OPERATION AND MAINTENANCE METHODS

(71) Applicant: ATEC Water Systems, LLC, Los Angeles, CA (US)

(72) Inventor: Lee Odell, Vancouver, WA (US)

(21) Appl. No.: 18/674,424

(22) Filed: May 24, 2024

(51) Int. Cl. B01D 35/12; B01D 29/66; B01D 35/157; C02F 1/00; C02F 103/06

(52) U.S. Cl. CPC B01D 35/12; B01D 29/668; B01D 35/1573; C02F 1/004; C02F 1/008; B01D 2201/165; C02F 2103/06; C02F 2201/005; C02F 2303/14; C02F 2303/16

(57) ABSTRACT

Embodiments described herein relate to a post filter set configured as parallel post filter branches. Each post filter branch includes a post filter, an upstream multi-position valve, and a downstream multi-position valve. Each the upstream and the downstream multi-position valves are actuatable to at least two configurations to enable backwashing and filter to waste operations using fewer valve operations. For backwashing, a head pressure from the combined output of other post filters in the post filter set is leveraged such that backwashing a particular post filter can be performed as a pumpless operation.

### TECHNICAL FIELD

Embodiments described herein relate to industrial duty water filtration systems and, in particular, to post filter arrangements and systems.

### BACKGROUND

Maintenance operations in respect of final-stage media filters used in water treatment are often costly and mechanically complicated. Specifically, conventional final-stage media filter systems often require up to four dedicated valves and associated plumbing for each media filter, each valve requiring a dedicated actuator and associated communication lines coupling to respective programmable logic units (PLUS). Each valve of each filter must be actuated in a specific order to effectively remove the filter from service and to begin maintenance operations, such as backwashing. Further, many regular maintenance operations (such as backwashing) expressly require separate water sources and additional circulation equipment, including high flowrate pumps.

These conventional maintenance systems and techniques introduce significant up-front and ongoing cost. For example, each valve introduces a potential leak path, each actuator introduces a potential mechanical/control failure point, pumps may require periodic maintenance and may consume significant power during maintenance operations, and operator or PLU errors in actuation order may delay maintenance operations, resulting in decreased production over an extended period of time.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified schematic control diagram of an example set of post filter assemblies, as described herein.

FIG. 2 depicts a simplified process flow diagram of an example set of post filter assemblies, as described herein.

FIGS. 3A-3F depicts a simplified flow schematic of a maintenance operation for an example set of post filter assemblies.

FIG. 4 depicts a flowchart of an example method of performing maintenance on a post filter, such as described herein.

FIG. 5 depicts a flowchart of an example method of performing maintenance on a post filter, such as described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to media filter systems for water treatment. In many embodiments, a media filter as described herein may be a final filtration stage of a larger water treatment pipeline, but this is not required of all embodiments and media filters as described herein can be located at any suitable stage of a water treatment process. For simplicity of description and illustration, the embodiments described herein reference example media filters operated as a final-stage filter of a water treatment process. Such media filters are referred to as “post filters” herein.

Further to the foregoing, embodiments described herein relate to configurations of post filter systems and methods for performing maintenance on such systems. The systems and methods described herein can be used to filter particles, dissolved solids, or other matter from groundwater, surface water, or other water sources.

Broadly, systems described herein leverage pressure and flow rate at an output header of a filter chain to serve as the high-pressure clean water input of a backwash process of a single post filter of an array of post filters. As a result of these constructions, mechanical complexity of water treatment systems is dramatically simplified, cost is reduced, and physical space requirements are reduced, thereby permitting installation of water treatment systems at a greater number of sites.

Specifically, each post filter of an array of multiple post filters can include two multi-position valves (e.g., three position valves), one at an input port (a port configured to receive water to be filtered when the respective post filter is in service) of each post filter and one at an output port (a port configured to provide water output when the respective post filter is in service) of each post filter. In service, each post filter's respective multi-position valve pair can be positioned to define a forward flow direction through that respective post filter. Operating in parallel, the output flow rate is the sum of the flow rates through each respective post filter in service. For example, if four post filters are in service and each filters water at 100 gallons per minute, combining the output of each post filter results in a flow rate of 400 gallons per minute. A person of skill in the art will appreciate that diameters of pipelines conveying water to, from, and through post filters may result in pressure changes, but the flow rate remains constant.

In this configuration, if an input port multi-position valve of one post filter is repositioned to decouple the post filter from source, flow rate through each of the remaining in-service post filters increases proportionately. If the same input port multi-position valve is opened to atmospheric pressure, however, a pressure gradient exists to induce a reversed flow within the post filter because the head pressure at the combined output of the in-service post filters is greater than atmospheric pressure. In this manner, the input multi-position valve of each respective post filter can—by its position alone, and without any external pressurizing source—selectively reverse flow within that respective post filter, presuming at least one other post filter remains in a forward flow configuration.

As may be appreciated, backward flow as described above, effectively backwashes the post filter at higher flow rate than the post filters' filtering flow rate. In this manner, the input multi-position valve's position itself defines two modes of the post filter: a filtering mode with forward flow; and a backwashing mode with backward flow.

Further embodiments described herein include a second multi-position valve at the output of each post filter. This valve can decouple a post filter in backwash mode from the output pipeline, effectively stopping flow within the post filter. Thereafter the input multi-position valve can be returned to the filtering mode position to encourage forward flow within the post filter. In this configuration, however, output of the post filter is directed to a reject stream for a period of time. In this manner, the output multi-position valve of each respective post filter can—by its position alone, and without any external pressurizing source—selectively connect output of the post filter to an output header or to a reject header.

As may be appreciated, forward flow with rejected output as described above, effectively forward-washes a post filter at the filtering flow rate. In this manner, the output multi-position valve's position itself defines two modes of the post filter: a filtering mode with forward flow; and a forward washing mode with forward flow.

These embodiments, including two multi-position valves for each post filter, effectively allow for automatic backwashing and forward flushing of post filters in a post filter array, while reducing valve counts (and actuators) by half over conventional system, and eliminate requirements for high power pumps or separate water sources dedicated to backwashing.

More generally and broadly, embodiments described herein relate to a post filter system that may be integrated in a water treatment system that reduces the start-up costs of the post filter system and improves the operation of the system during maintenance. Broadly, the post filter system includes multi-position valves arranged in pairs along a respective post filter branch. As noted above, each post filter branch can include a multi-position valve upstream of a post filter, one or more post filters (e.g., a volume suitable for retaining a quantity of water and a quantity of filter media(s)), and a multi-position valve downstream of the post filter. As described herein, upstream and downstream are used to refer to a position of hardware with respect to a post filter operating under normal operating conditions. Generally, each post filter system may include an array of post filters and/or an array of post filter branches, witch the system including at least two post filter branches.

The upstream multi-position valve may be positioned at a first node of the branch. At the node, the upstream multi-position valve is fluidly coupled to an inlet pipeline that conveys water from a source, a waste header, and a post filter (e.g., via a pipeline or other connecting hardware). The upstream multi-position valve includes at least a first configuration and a second configuration. The first configuration, also referred to as a filtering configuration, filtering mode, or a first mode, couples the flow from the source to the post filter and blocks flow to the waste header. The second configuration, also referred to as a maintenance configuration or a second mode, couples the flow from the post filter to the water header and blocks flow from the source.

The downstream multi-position valve may be positioned at a second node of the branch. At this node, the downstream multi-position valve is fluidly coupled to the post filter, the waste header, and a finished water pipeline that conveys filtered water to a finished water header. The downstream multi-position valve includes at least a third configuration and a fourth configuration. The third configuration, also referred to as an filtering configuration or a third mode, couples the flow from the post filter to the finished water header and blocks flow to the waste header. The fourth configuration, also referred to as a maintenance configuration or a fourth mode, couples the flow from the post filter to the waste header and blocks flow from the finished water header. It should be noted that the terms first, second, third, and fourth are used to differentiate different modes of different two different multi-position valves and do not indicate an order of operations nor number of configurations available for each of the multi-position valves.

For each branch, the post filter is between the upstream and the downstream multi-position valve. The post filter may be a post-reaction filter that separates particulate matter from a source or water supply. The post filter is configured to output filtered water that can be provided for utility water or other industrial applications. The post filter generally includes filter media that separates this particulate matter and which fills only a fraction of the container.

In some cases, each post filter branch operates in parallel with respect to the other post filter branches. Thus, a post filter branch may be isolated, shut down, or under maintenance while the other post filter branches continue to operate. Due to this configuration, each post filter branch may be serviced without completely stopping and/or without major impacts to the production of filtered water (depending on the number of filters and the capacity of each of the post filters).

Due to the configuration described above, a post filter may undergo maintenance using a reduced number of valve operations (compared to traditional systems, which require at least two) and using a pumpless operation. For example, to backwash the post filter, a single valve operation of the upstream multi-position valve is used to change the valve from the first configuration to the second configuration. This allows the flow of post filter to reverse by using the head pressure from the filtered water output from adjacent post filters—and thereby not requiring a pump to reverse flow.

Once backwashing is complete (e.g., once a first time period of filtered water flowing up the post filter and to the waste header has elapsed), the branch can be set up for a filter to waste operation. To set up for this operation, the upstream valve is actuated to the first configuration and the downstream valve is actuated to the second configuration. In this set up, source water flows from the inlet pipe, through the post filter, and to the waste header to settle the filter media following the backwash. Again, while traditional systems would require at least four separate valve operations, the described system reduces the valve operations to two. By reducing the number valves and valve operations, human error is less likely at least because the operation of the system is simplified. As above, due to the configuration of the valves at the respective first and second nodes, no pump is used to filter to waste. More simply, both filtration and automated backwashing can be “powered” by head pressure of the water source itself.

For simplicity, the system described herein presume a groundwater source, but this may not be required of all embodiments. In non-groundwater embodiments, an input pump may be required to establish appropriate pressure and/or flow rates.

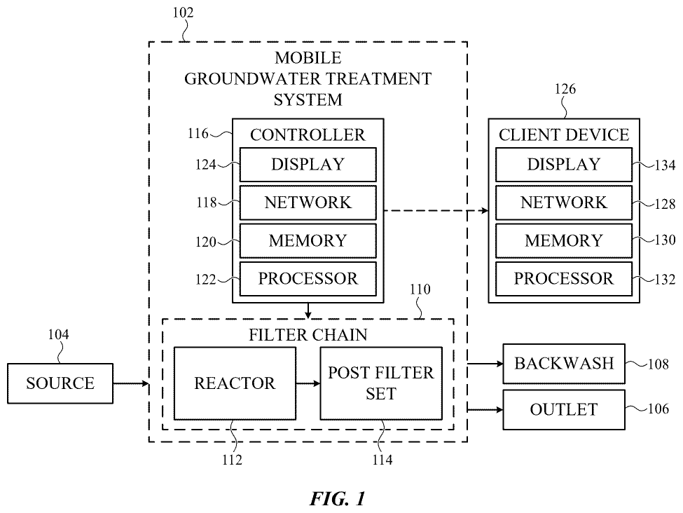

These foregoing and other embodiments are discussed below with reference to FIGS. 1-5. However, those skilled in the art will readily appreciate that the detailed description given herein with respect to these figures is for explanation only and should not be construed as limiting.

FIG. 1 depicts a simplified schematic of a water treatment system 102, which may be adapted for improved maintenance operations. Pipelines, equipment, enclosures, and the like are omitted from this figure for clarity.

Generally, the water treatment system 102 is configured to receive input water from a source 104. In some cases, the source may be groundwater. In some examples, the source may be a tank or other reservoir that conveys input water at an inlet head pressure. In some examples, a pump or other equipment may be used to provide the head pressure and/or flowrate needed at the inlet of the water treatment system 102.

The water treatment system 102 may include reactors, filters, and other equipment that treat the input water and produces filtered water. The filtered water is output via an outlet 106. The outlet 106 may refer to pipelines, tanks, containers, or the like which can be configurable to receive the filtered water. In some examples, particularly during maintenance operations, the water treatment system 102 may produce backwash 108. The backwash 108 may be recycled back to the inlet of the water treatment system 102 and/or safely disposed using industry standard procedures. Generally, water output to the backwash 108 may contain particulates and/or other contaminants which do not meet the same standards for filtered water that is output by the outlet 206.

The water treatment system 102 may include a filter chain 110. The filter chain 110 receives the input water from the source 104 (e.g., via one or more pipelines coupled to the source 104 and within the groundwater treatment system 102) and is coupled to the outlet 106 and to the backwash 108. The filter chain 110 may include a reactor 112 (which may not be required in all filter chains) and a post filter set 114. Water from the reactor 112 flows to the post filter set 114. In some cases, other intermediate steps may be performed prior to the water reaching the post filter set 114.

The post filter set 114 may include two or more filters which are configured to remove solids, contaminants, and the like, from the water. In some cases, each filter may include filter media through which a portion of the volume from the source flows. The post filter set 114 is coupled to the outlet 106 and/or to the backwash 108. The output line (e.g., outlet 106 or backwash 108) may depend on which mode the post filter set 114 is operating. For example, during normal operations, filtered water is output at the outlet 106. In maintenance operations, the flowrate of filtered water at the outlet 106 may decrease and the backwash 108 may be live to flush particulates from each filter.

In some cases, the filter chain 110 may be controlled by a controller 116. The controller may be communicatively coupled (e.g., via a network 118) to one ore more actuators, manifolds, injectors, and the like. In some cases, the controller 116 may include a memory 120 and a processor 122. The memory 120 and the processor 122 can be configured to instantiate an instance of a control software that causes the actuators, manifolds, injectors, or the like to actuate and/or otherwise change an operation parameter. For the post filter set 114, the controller 116 can be configured (e.g., via the network 118) to actuate multi-position valves to predetermined positioned and at predetermined times to perform periodic maintenance of the post filter set. In some cases, maintenance may be performed following a command (e.g., from a technician), in response to a condition (e.g., a sensor indicating maintenance of the filters is due), or the like. Generally, the controller 116 may include a display 124 which enables a user to view and/or monitor equipment configuration and other conditions.

In some examples, the controller 116 is also communicatively coupled to a client device 126 via a network 128. The client device 126 may be a laptop, desktop, tablet, phone, or the like having a processor 130, a memory 132, and a display 134. The client device 126 can be configured to operate the hardware from the water treatment system 102 via the controller 116. More specifically, the client device 126 can be configured to instantiate an instance of a client application (e.g., using processor 130 and memory 132) to access data from the controller, which may include operational parameters, sensor readings, status, control settings, or the like. In some cases, the client device 126 is on-site with respect to the water treatment system 102. In some cases, the client device 126 may be remote (e.g., communicating via Wi-Fi or similar).

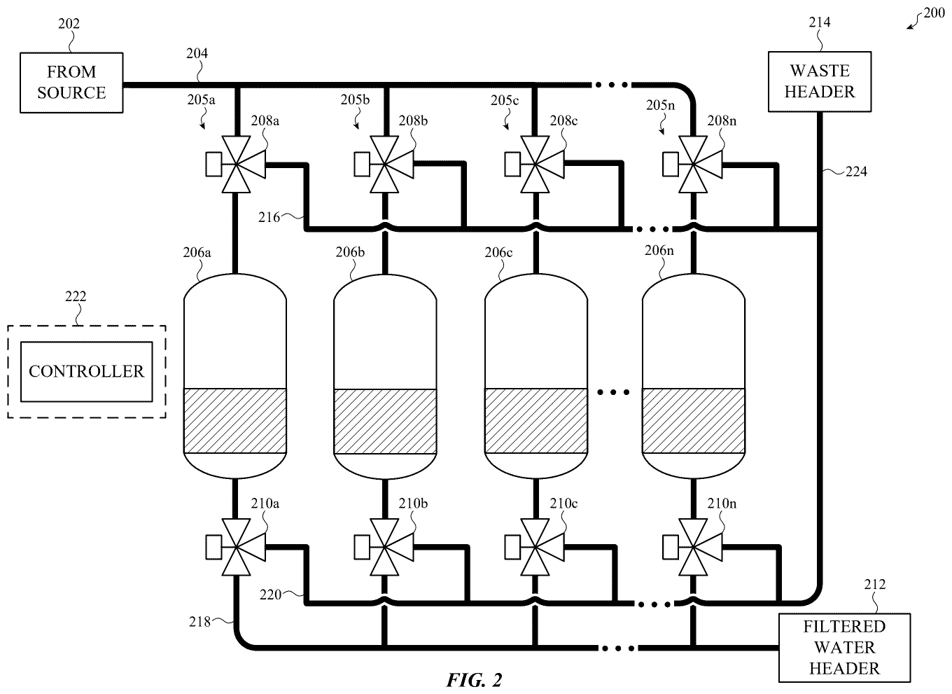

FIG. 2 depicts a simplified process flow diagram of a post filter set 200, which may be implemented in the post filter set 114 from FIG. 1. Generally, the post filter set 200 is configured to reduce the overall costs of the system (particularly, the cost of hardware associated with the maintenance of the system) and reduce the complexity of maintenance operations of the post filter set 200 without decreasing the reliability of the system and without decreasing the maintenance capabilities of the post filter set 200. The post filter set 200 leverages multi-position valves that redirect the flow along different headers, depending on the maintenance stage.

The post filter set 200 first receives input water from a source 202. The source 202 may be a well-water source or partially-treated groundwater (water which has been past a reactor or other water treatment hardware) at intermediate stages of the treatment process, as an example. The source 202 may convey input water at an initial head pressure and initial flowrate via an input pipeline 204. The input pipeline 204, in turn, may include multiple branches 205a-n which convey the input water to each of the different post filters, 206a-n.

In some embodiments, each of the post filters 206a-n have a capacity less than the initial flowrate and a working pressure less than the initial head pressure. For example, each pipeline and equipment at each branch 205a-n may have a smaller diameter than pipeline 204. In some cases, each branch 205a-n may be isolated from the system 300 for servicing without impacting (or minimally impacting) the amount of filtered water output via a filtered water header 212.

In some cases, each branch 205a-n may have the same equipment configuration. For example, branch 205a may include an upstream multi-position valve 208a, a post filter 206a, and a downstream multi-position valve 210a. As depicted, the upstream multi-position valve 208a couples the input water from source 202 to the post filter 206a. The multi-position valve 208a also couples branch 205a to a backwash header 214 via pipeline 216.

The multi-position valve 208a may have different actuation positions (referred to herein as “configurations”) that redirect the flow to different branches and which isolate different headers or branches. For example, a first configuration of the upstream multi-position valve 208a directs the flow from pipeline 204 to the post filter 206a and prevents flow to or from pipeline 216. The first configuration may also be referred to as an operation mode or filtering configuration. In normal operating conditions, the multi-position valve may be open to the first configuration.

In the second configuration of the multi-position valve 208a, flow is directed from the post filter 206a to pipeline 216 and to waste header 214 and blocks flow to/from pipeline 204. The second configuration may be referred to as a maintenance mode or maintenance configuration. Generally, this configuration may be used to receive backwash from the post filter 206a and direct the backwash to the waste header 214 via pipeline 224.

As discussed above, the post filter 206a is configured to provide filtered water. In particular, the post filter 206a may have a filter depth of filter media configured to arrest precipitates. In some examples, the filter media is manganese dioxide, but this is merely one example; in other cases, other filter media may be preferred.

The filtered water effluent the post filter 206a may flow towards the downstream multi-position valve 210a. Similar to the upstream valve 208a, the downstream multi-position valve 210a may have multiple configurations and it is operable to redirect the flow to different branches, according to the operating condition of the system 200. In a third configuration (e.g., the normal operating condition), the multi-position valve 210a directs filtered water from the post filter 206a to the filtered water header 212 via pipeline 218. In a fourth configuration (e.g., maintenance condition), the multi-position valve 210a directs water from the post filter 206a to the waste header 214 via pipeline 220.

More generally, the upstream multi-position valves 208a-n and the downstream multi-position valves 210a-n may be bidirectional valves in one or more valve configurations. Each of the valves 208a-n and 210a-n may be configured to be actuated via a mounted actuator that is powered and/or controlled via a controller 222. The controller 222 is communicatively coupled to each valve actuator. In some cases, valves 208a-n and 210a-n may be manually operated. Each valve may be formed from a material rated for the operating condition (e.g., input water with contaminants, backwash, filtered water) of the system 200.

As described herein, multi-position valves are used to describe valves which are coupled to more than one branch and/or header. For example, multi-position valves 208a-n and 210a-n may be three-way valves. More specifically, multi-position valves 208a-n and 210a-n may be an L-type three-way valves or T-type three-way valves. In the example of the L-type three-way valve, the three-way valves may have three configurations: the first configuration in the operation mode; the second configuration in the maintenance mode; and a closed configuration. In the example of the T-type valve, the three-way valve may have four configurations, including the first configuration in operation mode, the second configuration in maintenance mode, an all-branches-open configuration, and a source-to-waste header configuration. In some cases, the multi-position valves 208a-n and 210a-n may be a four way valve or larger or a manifold comprising more than one valve. For example, the valves 208a-n may include an equalizer port, a bleed port, or other ports for tapping or intervention, as may be known to one of skill in the art.

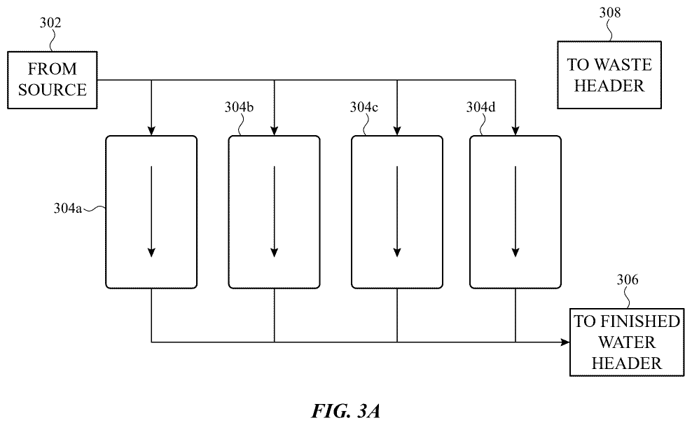

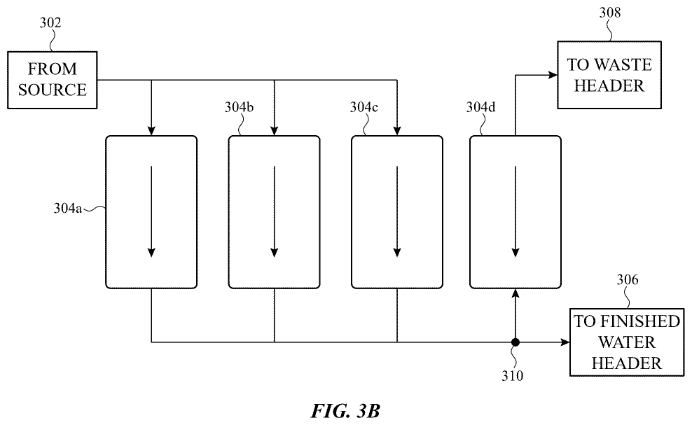

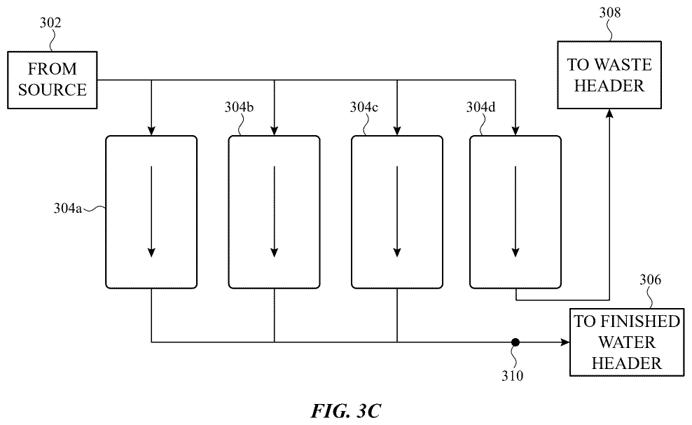

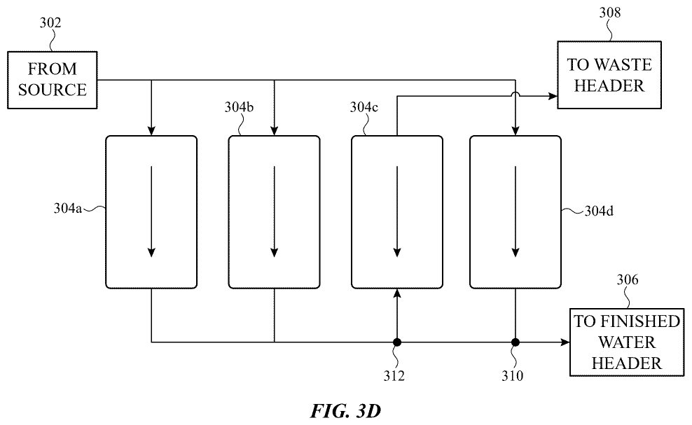

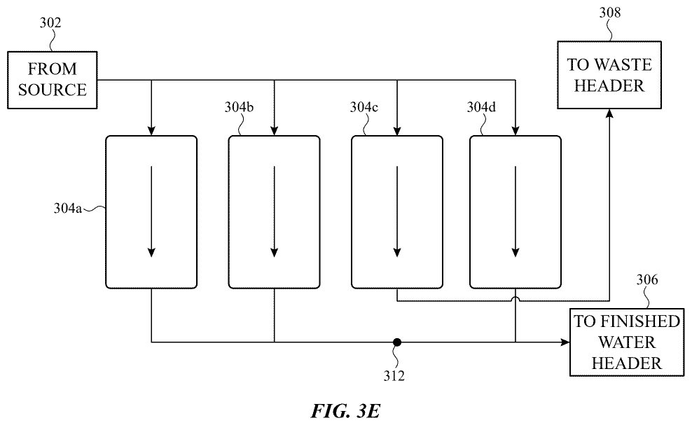

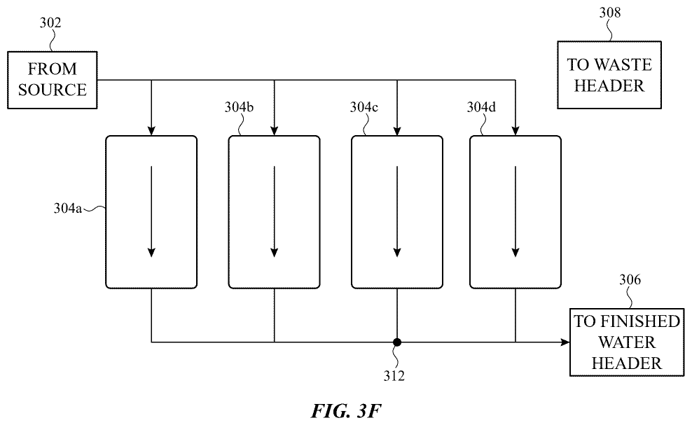

FIGS. 3A-3F depict a simplified flow schematic showing the steps of a maintenance procedure of a post filter set. Hardware, including valves, are omitted from these schematics for clarity. The operation is shown for a system having four filters. However, this operation may be scalable up to any number of post filters or down to as little as two post filters. FIG. 3A shows a flow diagram prior to the start maintenance operation (e.g., a normal operation mode for the system). In this schematic, input water from a source 302 flows to a respective post filter 304a-d. Filtered water output from each respective post filter 304a-d, flows to a finished water header 306.

FIG. 3B shows a first operation to service post filter 304d. In this operation, the flow from source 302 to post filter 304d is blocked (e.g., using a multi-position valve). Blocking flow from the source 302 to the post filter 304d may simultaneously open the flow from the post filter 304d to a waste header 308. In this position, the flowrate from the source 302 remains the same. However, instead of the flow from the source 302 being distributed to four post filters, the same flow is now distributed to three post filters. Thus, during this maintenance operation, the post filters 304a-c produce more filtered water per unit than under normal operating conditions. The combined flowrate entering node 310 is the same as the flowrate from the input water from source 302. At node 310, filtered water flows to both the finished water header 306 and to the post filter 304d.

In some examples, the post filter 304d and the waste header branch 308 may be at a first pressure P1 and the finished water header may be at a pressure P2. In some cases, P1 may be greater than P2. Generally, the pressure and/or flowrate upstream of node 310 is sufficient such that filtered water from post filters 304a-c can backwash the post filter 304d without additional equipment, such as pumps. Thus, a portion of the filtered water at node 310 flows up to backwash post filter 304d. In some cases, the amount of filtered water that flows up for backwashing the filter may depend on an optimal backwash flow rate specific to the filter.

In these cases, a choke or other flow-control hardware may be used to adjust the rate of water entering post filter 304d. The rest of the filtered water that does not flow up to backwash post filter 304d, flows to the finished water header 306. Generally, due to this arrangement, the rate of filtered water produced decreases during maintenance. For example, the produced filtered water may decrease by 25% in this example. This configuration is maintained until the backwash of the post filter 304d is complete, which may be in the order of minutes or hours, depending on the specifications and/or requirements of the system.

Once the backwash of filter 304d is complete, two valve operations are performed, as depicted in FIG. 3C. In the first valve operation, flow from the post filter 304d to the waste header 308 is closed and flow from the source 302 to the post filter 304d is opened. As discussed above in FIG. 2, this may be a single valve operation due to the multi-position valve. In the second valve operation, flow from the post filters 304a-c (e.g., at node 310) to the post filter 304d is closed and flow from downstream of post filter 304d to waste header 308 is opened. This second operation may be a single operation of a multi-position valve. While these two valve operations are described in terms of “first” and “second,” one of skill in the art would appreciate that these operations may be performed in either order. In some cases, the operations may be performed concurrently.

In this configuration, the post filter 304d is set up in a filter-to-waste configuration. In this configuration, input water is run through the post filter 304d to reduce turbidity in the water following the backwash of the filter. In some cases, the allowed turbidity may depend on the application. For example, the filter-to-waste configuration may be performed until the turbidity is 0.1 NTU or less, 1 NTU or less, 5 NTU or less, or similar.

After the filter-to-waste operation on post filter 304d is complete, post filter 304d is configured to a normal operation mode, as shown in FIG. 3D. In a first valve operation, the flow downstream from post filter 304d to the waste header 308 (e.g., in the filter to waste configuration) is closed, and the flow from the post filter 304d to the finished water header 306 is opened. Thus, post filter 304d is put back to normal operation. Next, subsequent post filters can be serviced.

In the example depicted in FIG. 3D, post filter 304c is serviced next. Similar to the procedure described in FIG. 3B, the flow of input water from source 302 is closed to post filter 304c and the flow from post filter 304c to water header 308 is open using a multi-position valve (e.g., may be a single valve operation). By performing this operation, the flow in the post filter 304c reverses, thereby backwashing the post filter 304c. More specifically, a portion of the flow from post filters 304a, 304b, and 304d is redirected at node 312 to post filter 304c (e.g., due to the pressure differential between the filtered water pipeline that convey filtered water to the finished water header 306 and the waste header, which may be at atmospheric pressure.

After backwashing of post filter 304c is complete, the system next actuates the multi-position valves upstream and downstream of the post filter 304c for the filter-to-waste configuration, as shown in FIG. 3E. Similar to the filter-to-waste configuration described above, input water from the source is recoupled to the post filter 304c and flow to the waste header from the post filter 304c is shut. Downstream of the post filter 304c, water flows to the waste header for the duration of the filter-to-waste operation while flow towards the finished water header from the post filter 304c is closed.

FIG. 3F depicts the flow in a normal operating condition once the filter-to-waste is complete in post filter 304c. Here, the downstream multi-position valve closes flow to the waste header and reopens flow to the finished water header. Afterwards, subsequent post filters (e.g., 304a and 304b) may be serviced.

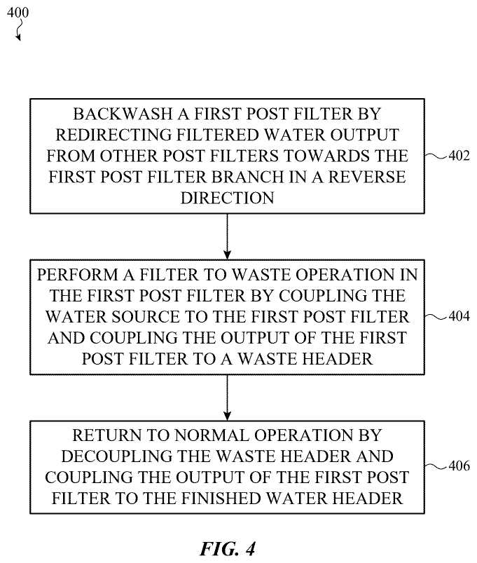

FIG. 4 depicts a flowchart of an example method 400 of performing a maintenance operation. At operation 402, backwashing of a post filter being serviced is performed. The backwash is done by redirecting flow from other post filters in the system upwards through the post filter being serviced. The water output from the backwash (e.g., including particulates) then flows to a waste header. Due to the waste header being at atmospheric pressure, the head from the filtered water causes the water to flow in the reverse direction through the post filter to backwash it.

At operation 404, the filter to waste operation is performed. At this operation, water from a source is coupled to the post filter being serviced and the post filter flows water through a normal direction. The output from the post filter is directed to the waste header for a period of time.

At operation 406, the post filter returns to normal operation. At this operation, the post filter is decoupled from the waste header and recoupled to the finished water header. Accordingly, water flows from the source, through the post filter, and to the finished water header to produce filtered water.

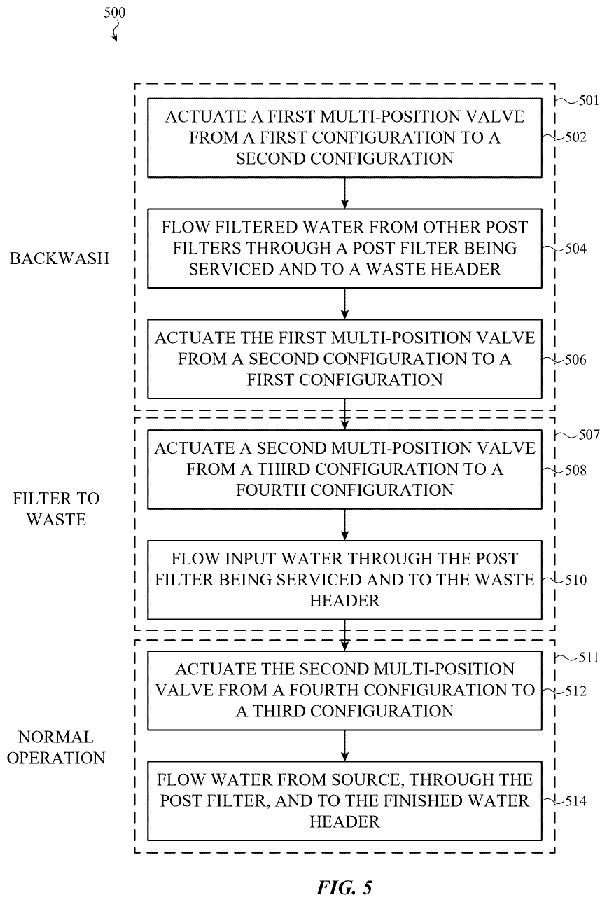

FIG. 5 depicts a flowchart of an example method 500 for operating hardware to perform a maintenance operation in a post filter. At operation 501, the backwash of the post filter is first performed. The backwash operation 501 may include steps 502, 504, and 506. At operation 502, a first multi-position valve is actuated. The actuation of the first multi-position changes its configuration from a first configuration (e.g., an operation mode) to a second configuration (e.g., a maintenance mode). The second configuration enables a reverse flow of the post filter being services.

At operation 504, filtered water from the other post filters (e.g., the other post filters under normal filtering configurations) is run through the post filter in the reverse direction. The flow goes from a bottom of the post filter being serviced, to the top of the post filter being serviced, and then to a waste header. Generally, the pressure of the filtered water is larger than the pressure of the waste header, allowing the flow to reverse and backwashing the filter media of the post filter. Once the backwash period is complete, at operation 506, the first multi-position valve is actuated from the second configuration to return the valve to the first configuration.

Next, at operation 507, the filter to waste operation may be initiated. At operation 508, a second multi-position valve (downstream of the post filter with respect to a normal operation mode) is actuated from a third configuration to a fourth configuration. Due to this change in position of the valve, at operation 510, the flow from the post filter is routed to the waste header rather than the finished water header.

Operation 511 depicts a return to normal operation of the post filter from the filter to waste operation. At operation 512, the second multi-position valve is actuated from the fourth configuration back to the third configuration. This position allows the flow, as shown in operation 514, to be conveyed from the source, through the post filter, and to the finished water header.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate operation order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

What is claimed is:

1. A water filtration system comprising:
a backwash pipeline coupled to a backwash header;
an inlet configured to receive input water at a head pressure;
an output water pipeline coupled to a finished water header;
a set of media filters coupling the inlet to the output water pipeline and configured to provide filtered output water at the head pressure via the output water pipeline; and
a set of multi-position valves arranged in pairs, each pair associated with a respective one media filter of the set of media filters, each pair configured to:
in a first configuration, couple the respective media filter to the output water pipeline such that water flows in a first direction in each respective media filter; and
in a second configuration:
decouple the respective media filter from the inlet; and
couple the respective media filter to the backwash pipeline such that water flows in a second direction opposite the first direction within the respective media filter.

2. The water filtration system of claim 1, wherein:
the water filtration system further comprises a filter to waste pipeline coupled to the backwash header;
the decoupling the respective media filter from the inlet and the coupling the respective media filter to the backwash header such that water flows in a second direction takes place during a first time period; and
the second configuration further comprises:
for a second time period following the first time period:
decouple the respective media filter from the backwash pipeline;
couple the respective media filter to the inlet such that water flows in the first direction within the respective media filter; and
couple the respective media filter to the filter to waste pipeline.

3. The water filtration system of claim 1, wherein each valve of the set of multi-position valves are three-way valves.

4. The water filtration system of claim 3, wherein the set of multi-position valves are L-type valves.

5. The water filtration system of claim 1, wherein:
the water filtration system includes a maintenance mode and an operation mode;
in the maintenance mode:
a subset of multi-position valves of the set of multi-position valves are set to the first configuration, the subset of multi-position valves corresponding to a subset of media filters of the set of media filters; and
a first multi-position valve pair of the set of multi-position valves is configured in the second configuration, the first multi-position valve pair different from the subset of multi-position valves, the first multi-position valve pair corresponding to a first media filter;
in the second configuration of the first multi-position valve pair:
a first portion of the output filtered water from the subset of media filters flows to the finished water header; and
a second portion of the output filtered water flows from the subset of media filters flows to the first media filter without using a pump.

6. The water filtration system of claim 5, wherein:
in the maintenance mode, the first multi-position valve pair is further configured to:
while in the second configuration:
recouple the inlet to the first media filter; and
isolate the output filtered water from the first media filter; and
couple an output of the first media filter to the backwash header.

7. The water filtration system of claim 1, wherein the set of multi-position valves include a respective actuator.

8. A groundwater filtration system comprising:
an inlet configured to receive input water from a water source at a flowrate;
a filtered outlet configured to output filtered water;
a backwash outlet configured to receive water;
an array of post filter assemblies positioned downstream of the inlet and upstream of the filtered outlet and the backwash outlet, each post filter assembly of the array of post filter assemblies comprising:
a respective post filter;
a respective first multi-position valve positioned upstream of the respective post filter, the respective first multi-position valve having:
a first filtering configuration configured to convey input water from the inlet to the respective post filter; and
a first maintenance configuration configured to convey water from the respective post filter to the backwash outlet; and
a respective second multi-position valve positioned downstream of the respective post filter, the respective second multi-position valve having:
a second filtering configuration configured to convey filtered water from the respective post filter to the filtered outlet; and
a second maintenance configuration configured to convey filtered water from at least one post filter of the array of post filter assemblies to the backwash outlet.

9. The groundwater filtration system of claim 8, wherein the array of post filter assemblies comprise at least three post filter assemblies.

10. The groundwater filtration system of claim 8, wherein:
each respective first multi-position valve comprises a respective first actuator communicatively coupled to a controller;
each respective second multi-position valve comprises a respective second actuator communicatively coupled to the controller;
the controller is configured to:
during a first time period:
set a particular first multi-position valve to the first maintenance configuration; and
set a particular second multi-position valve to the second filtering configuration; and
during a second time period subsequent to the first time period:
set the particular first multi-position valve to the first filtering configuration; and
set the particular second multi-position valve to the second maintenance configuration.

11. The groundwater filtration system of claim 10, wherein:
a particular post filter is between the particular first multi-position valve and the particular second multi-position valve; and
during the first time period, flow through the particular post filter reverses such that filtered water flows from the second multi-position valve to the first multi-position valve via a pressure differential generated by filtered water output from at least two post filter assemblies of the array of post filter assemblies with respect to the backwash outlet.

12. The groundwater filtration system of claim 8, wherein:
each respective first multi-position valve and each respective second multi-position valve is a single three-way valve.

13. The groundwater filtration system of claim 12, wherein the three-way valve is a T-type valve.

14. The groundwater filtration system of claim 8, wherein:
each respective first multi-position valve comprises a closed configuration configured to block flow from the inlet, from the backwash outlet, and from the respective post filter.

15. A method for performing maintenance to an array of post filter branches coupled to a water treatment system, the method comprising:
actuating a first actuator of a first three-way valve from a first configuration to a second configuration, the first configuration fluidly coupling an inlet to a first post filter, the second configuration fluidly coupling the first post filter to a waste header;
subsequent to actuating the first actuator to the second configuration, conveying filtered water at a first pressure to the first post filter in a first direction reverse of an operating condition of the first post filter, the filtered water at the first pressure output from an array of post filters different from the first post filter, the output from the array of post filters combined to define the first pressure without a use of a pump, the waste header at a second pressure less than the first pressure; and
subsequent to conveying the filtered water at the first pressure to the first post filter, actuating the first actuator to the first configuration.

16. The method of claim 15, comprising:
subsequent to conveying the filtered water at the first pressure to the first post filter, actuating a second actuator of a second three-way valve from a third configuration to a fourth configuration, the third configuration fluidly coupling a filtered water outlet to the first post filter, the fourth configuration fluidly coupling the first post filter to the waste header; and
subsequent to actuating the second actuator to the fourth configuration, conveying source water to the waste header via the first post filter, the source water flowing in a second direction corresponding to the operating condition of the first post filter.

17. The method of claim 16, comprising:
subsequent to conveying source water to the waste header, actuating the second actuator to the third configuration.

18. The method of claim 16, wherein:
the filtered water is conveyed at the first pressure to the first post filter for a first time period; and
the source water is conveyed to the waste header for a second time period.

19. The method of claim 15, wherein the first post filter comprises a manganese dioxide filter media.

20. The method of claim 15, wherein the first three-way valve is an L-type valve.
